(19) United States
(12) Patent Application Publication
(10) Pub. No.: US 2025/0351239 A1
(43) Pub. Date: Nov. 13, 2025

(54) MICROWAVE OVEN AND CORRESPONDING DOOR FOR THE MICROWAVE OVEN

(71) Applicant: WHIRLPOOL CORPORATION, Benton Harbor, MI (US)

(72) Inventors: Roy QIU, Shenzhen (CN); Joshua WU, Shenzhen (CN); Ping WU, Shenzhen (CN)

(21) Appl. No.: 18/660,640

(22) Filed: May 10, 2024

(51) Int. Cl. H05B 6/64; H05B 6/76

(52) U.S. Cl. CPC H05B 6/6414; H05B 6/763

(57) ABSTRACT

A microwave oven includes a housing and a door. The housing defines an internal cavity. The door is movably secured to the housing. The door has a glass pane and a mesh sheet. The mesh sheet is secured to an internal surface of the glass pane and is exposed along an interior side of the door. The housing and mesh sheet collectively form a faraday cage when the door is in a closed position.

### TECHNICAL FIELD

The present disclosure relates to an appliance that is configured to cook food, such as a microwave oven.

### BACKGROUND

Microwave ovens may include doors that are rotatably secured to main portions of the microwave ovens.

### SUMMARY

A microwave oven includes a housing and a door. The housing defines an internal cavity configured to receive foodstuffs therein. The door is rotatably secured to the housing. The door has a glass pane and a mesh sheet. The mesh sheet is secured to an internal surface of the glass pane and is exposed along an interior side of the door. The housing and mesh sheet collectively form a faraday cage when the door is in a closed position. The mesh sheet defines orifices. The mesh sheet includes bridges of solid material separating the orifices. The orifices each have a first dimension spanning opposing ends of the orifices. The bridges each have a second dimension spanning the bridges and extending between adjacent orifices. A ratio of the first dimension to the second dimension ranges between 10 and 60.

A microwave oven door includes a frame, a transparent pane, and a mesh sheet. The frame defines a central opening, has an exterior surface extending around an outer periphery of the central opening, and has a recessed region extending inward from the exterior surface. The recessed region extends around the outer periphery of the central opening and is disposed between the exterior surface and the central opening. The transparent pane has an outer surface and an inner surface. The transparent pane is secured to the frame within the recessed region such that the outer surface is planar with the exterior surface of the frame. The mesh sheet defines an array of orifices and is secured to the inner surface of the transparent pane such that the mesh sheet is planar with an interior surface of the frame and is exposed along an interior side of the frame via the central opening. The mesh sheet is collectively configured to form a faraday cage with a microwave housing.

A microwave oven includes a housing and a door. The housing defines an internal cavity. The door is movably secured to the housing. The door has a glass pane and a mesh sheet. The mesh sheet is secured to an internal surface of the glass pane and is exposed along an interior side of the door. The housing and mesh sheet collectively form a faraday cage when the door is in a closed position.

### BRIEF DESCRIPTION OF THE DRAWINGS

FIG. 1 is a front perspective view of a microwave oven with a microwave oven door in an open position;

FIG. 2 is an exploded view of the microwave oven door;

FIG. 3 is a partial cross-sectional view of the microwave oven door taken along line 3-3 in FIG. 1;

FIG. 3A is a magnified view of area 3A in FIG. 3;

FIG. 4 is a magnified schematic illustration of a first hole pattern of a mesh sheet that forms a portion of the microwave oven door;

FIG. 5 is a magnified schematic illustration of a second hole pattern of the mesh sheet that forms a portion of the microwave oven door; and

FIG. 6 is a set of graphs comparing the microwave choke of the microwave oven door described herein to the microwave choke of a traditional microwave oven door.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

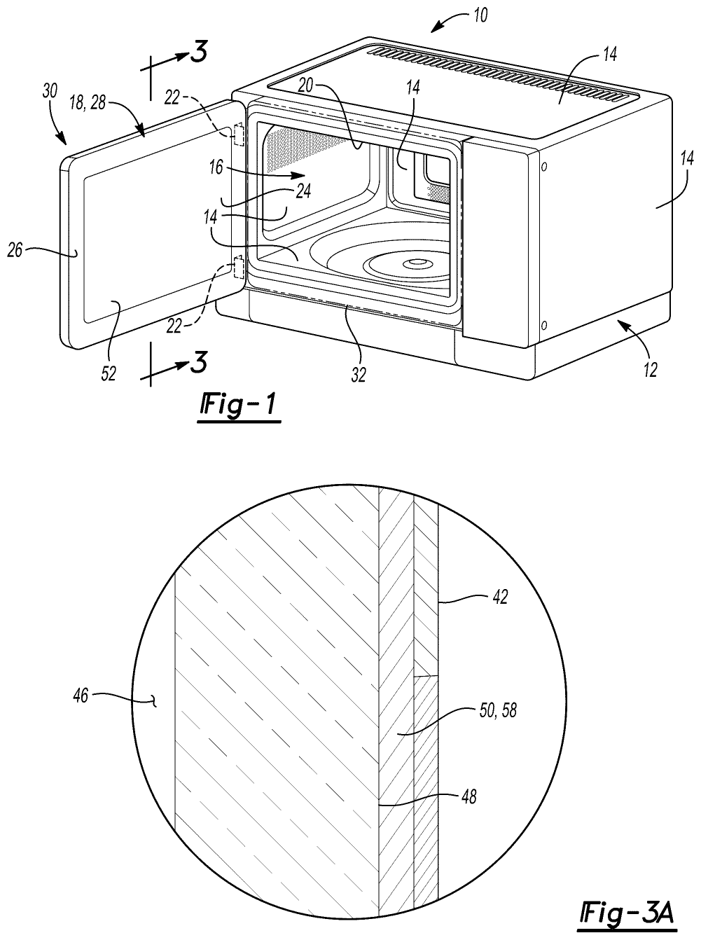

Referring to FIG. 1, a front isometric view of a microwave oven 10 is illustrated. The microwave oven 10 includes a housing 12. The housing includes a plurality of panels or walls 14 that define an internal cavity 16 in which food or foodstuffs may be placed or received for cooking. The plurality of walls 14 may include a top wall, a bottom wall, and three side walls. The housing 12 may further define an opening 20 configured to provide access to the internal cavity 16. The microwave oven 10 also includes a door 18 that is movably attached or secured to the to the housing 12. For example, the door 18 may be rotatably secured or attached to the housing 12 via hinges 22 along a first end or first side 24 of the door 18.

A handle (not shown in FIG. 1) may be secured to or defined along a second end or second side 26 of the door 18. The door 18 may comprise a panel 28 and said handle, where the panel 28 may be rotatably secured or attached to the housing 12 via the hinges 22. More specifically, the panel 28 may be comprised of a plurality of plates, external panels, or subpanels that are secured to each other and define an internal pocket or cavity (not shown in FIG. 1). For example, the panel 28 may comprise a plurality of metal plates or sheet metal subpanels that are secured to each other and define an internal pocket or cavity. The door 18 is configuring to pivot relative to the housing 12 via the hinges 22 in response to a user engaging the handle to transition the door between an open position 30 and a closed position 32. The door 18 provides access to the opening 20 and internal cavity 16 when in the open position 30. The door 18 covers the opening 20 and internal cavity 16 when in the closed position 32. The door 18 may be one of several embodiments described in further detail below. Therefore, the door 18 as illustrated in FIG. 1 should not be construed as limiting.

The microwave oven 10 may include a microwave generating device, such as a magnetron or a solid-state device. The microwave oven 10 may include a waveguide that defines a pathway or channel on an opposing side of a wall of the plurality of walls 14 relative to the internal cavity 16. The wall of the plurality of walls 14 may define an orifice that establishes communication between the internal cavity 16 and the pathway or channel. A waveguide cover may be disposed over the orifice within the internal cavity 16. The pathway or channel of the waveguide is configured to direct microwaves from the microwave generating device, through the waveguide cover, and to the internal cavity 16 in order to cook any food that is disposed within the internal cavity 16.

The microwave oven 10 may also include a power supply, such as a transformer, that provides electrical power to the microwave generating device, a capacitor, and a cooling fan. The cooling fan may be configured to cool the various components of the microwave oven 10, such as the microwave generating device, power supply, capacitor, etc. Please note that for illustrative purposes, the electrical connections between the various components of the microwave oven 10 and the electrical connection between the microwave 10 and an external power source (e.g., an electrical plug and outlet connection) are not shown.

The electronic components (e.g., microwave generating device, fan motors, power supply, capacitors, etc.) of the microwave oven 10 may be connected to a control panel, such as a human machine interface (HMI), and a controller, so that an operator may control various parameters. For example, the operator may be configured to input a cooking time, a cooking temperature, a desired mode of cooking (e.g., microwave cooking, defrost, etc.).

The controller may be part of a larger control system and may be controlled by various other controllers throughout the microwave oven 10. It should therefore be understood that the controller and one or more other controllers can collectively be referred to as a “controller” that controls various functions or components of the microwave oven 10 in response to signals from various sensors to control the various functions or components of the microwave oven 10. The controller may include a microprocessor or central processing unit (CPU) in communication with various types of computer readable storage devices or media (e.g., a non-transitory computer readable medium having instructions stored thereon). Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the microwave oven 10.

Control logic or functions performed by the controller may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based controller. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the microwave oven 10. The computer-readable storage devices or media may include one or more of a number of known physical devices which utilize electric, magnetic, and/or optical storage to keep executable instructions and associated calibration information, operating variables, and the like.

Referring to FIGS. 1-5, the door 18 and elements of the door 18 are illustrated in further detail. The door 18 includes a frame 34 defining a central opening 36. The frame 34 may also be referred to as a chock cover or choke plate. The frame 34 includes an exterior surface 38 extending around an outer periphery 40 of the central opening 36. The frame 34 further includes a recessed region 42 extending inward from the exterior surface 38. The recessed region 42 extends around the outer periphery 40 of the central opening 36 and is disposed between the exterior 38 surface and the central opening 36.

The door 18 includes a transparent plate or pane of material. More specifically, the transparent plate or pane of material may be made from a transparent plastic, tempered glass, a glass ceramic material, tinted glass, etc. The transparent plate or pane of material may be referred to as the glass plate or glass pane 44. The glass pane 44 has an external or outer surface 46 and an internal or inner surface 48. The glass pane 44 may be secured to the frame 34 within the recessed region 42 such that the outer surface 46 planar with the exterior surface of the frame 34.

The door further includes a mesh layer or mesh sheet 50 that is secured to the inner surface 48 of the glass pane 44. The mesh 50 may be secured to the glass pane 44 via a high temperature resistant glue, such as, but not limited to, silicone glue. The mesh sheet 50 is exposed along an interior side 52 of the door 18. The mesh sheet 50 also faces into and is exposed from within the internal cavity 16 when the door 18 is in the closed position 32. The housing 12 of the microwave oven 10 and the mesh sheet 50 collectively form a faraday cage when the door 18 is in the closed position 32. The mesh sheet 50 defines an array of holes, apertures, or 62. The mesh sheet 50 may be secured to the inner surface 48 of the glass pane 44 such that the mesh sheet 50 is planar with the interior surface 56 of the frame 34 and is exposed along the interior side of the frame 34 via the central opening 36. The interior surface 56 of the frame 34 may be defined along the recessed region 42.

The mesh sheet 50 may have a base plate or base sheet 58 and an outer foil layer 60 that provides an aesthetic smooth appearance. The base sheet 58 and the outer foil layer 60 may be made from metallic materials. The base sheet 58 and the outer foil layer 60 may be made from the same material or different materials.

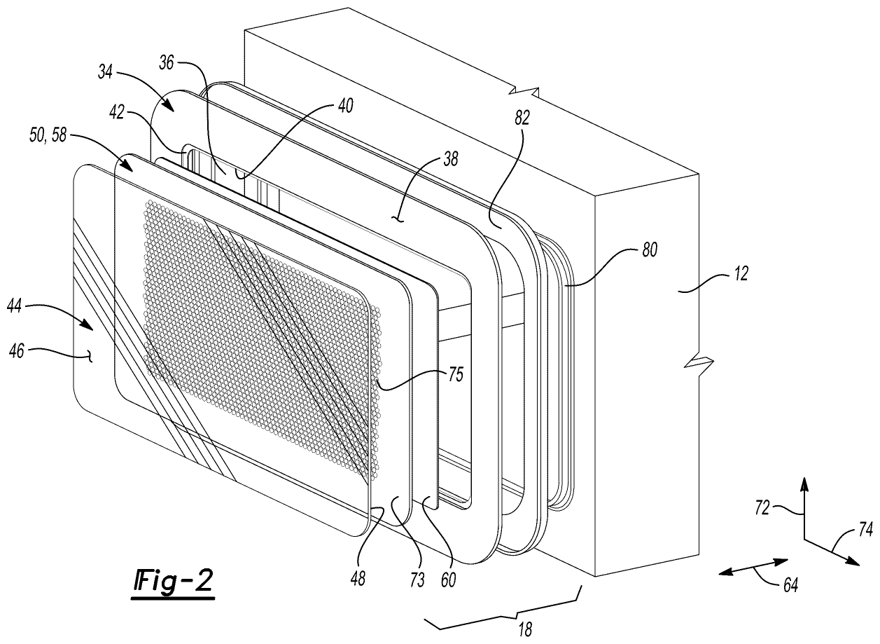

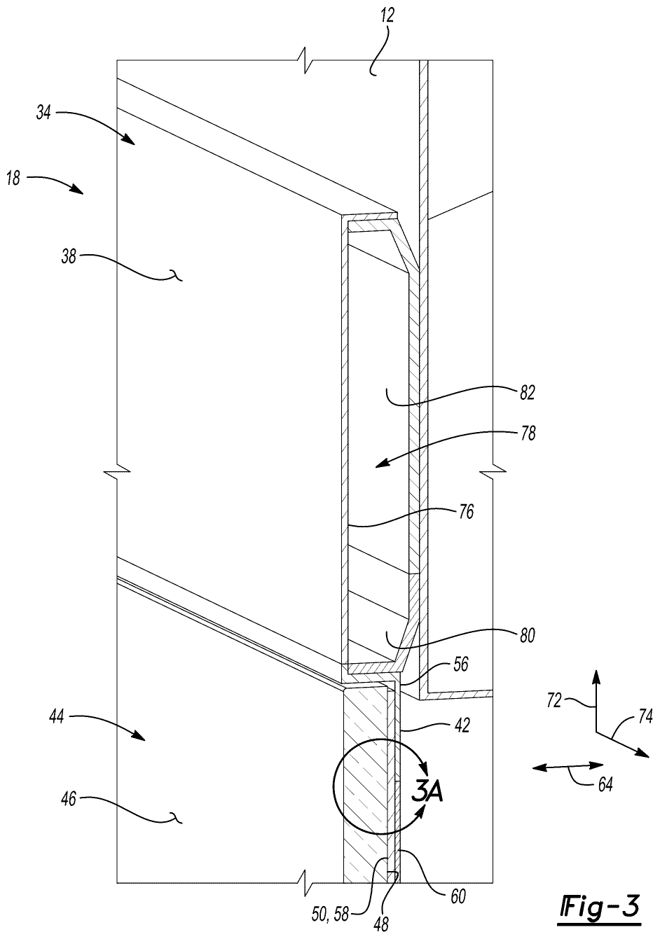

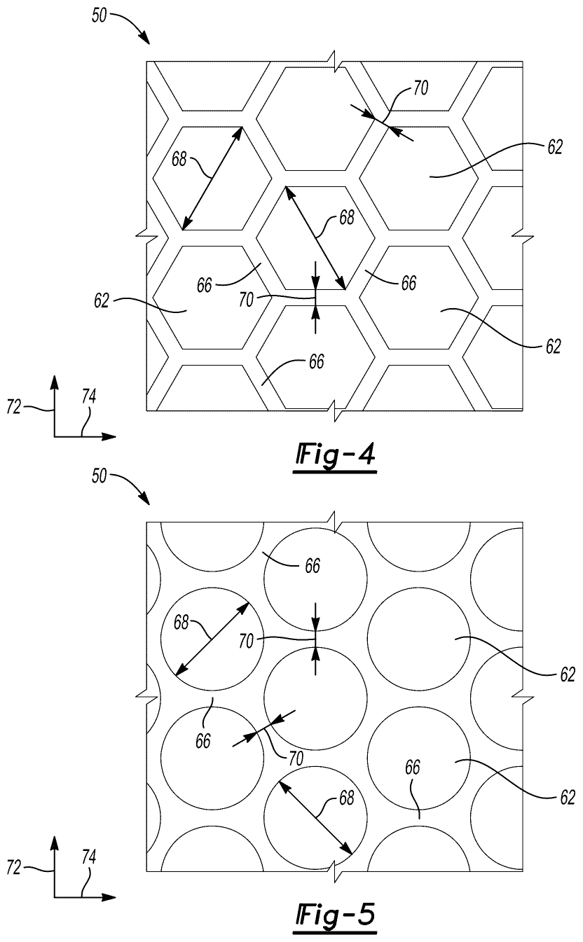

The holes, apertures, or orifices 62 may be created via chemical etching or other process. The orifices 62 may extend through the mesh sheet 50 along a thickness of the mesh sheet 50 (e.g., the orifices may extend through the mesh sheet 50 in direction 64 in FIGS. 2 and 3, and/or into the sheet in FIGS. 4 and 5). The mesh sheet 50 includes bridges 66 of solid material separating the orifices 62. The orifices 62 may each have a first dimension 68 spanning opposing ends of the orifices 62. The bridges 66 each have a second dimension 70 spanning the bridges 66 and extending between adjacent orifices 62. A ratio of the first dimension 68 to the second dimension 70 may range between 10 and 60.

The orifices 62 may be hexagonal in shape and the first dimension 68 of each orifice 62 may correspond to a long diagonal dimension of the hexagonal shape of the corresponding orifice 62 (e.g., See FIG. 4). The orifices 62 may be circular in shape and the first dimension 68 of each orifice 62 may correspond to a diameter of the corresponding orifice 62 (e.g., See FIG. 5). The second dimension 70 of each bridge 66 may correspond to a shortest distance between corresponding adjacent orifices 62 along each bridge 66. The patterns of the orifices 62, the first dimension 68 along each orifice, and the second dimension 70 along each bridge 66 may be uniform as illustrated or may be vary between the orifices 62 and the bridges 66 as long the ratio of the first dimension 68 to the second dimension 70 maintains a range between 10 and 60.

The orifices may have a one-dimensional density along the mesh sheet 50 that ranges between 10 and 20 orifices per inch (OPI). The one-dimensional density may be determined in a direction that is perpendicular or orthogonal to the thickness of the mesh sheet (e.g., a direction that is perpendicular or orthogonal to direction 64). For example, the one-dimensional density may be determined along direction 72 or direction 74. Direction 72 and direction 74 may also be perpendicular or orthogonal to each other, and may form a plane that extends along the mesh 50. The orifices may also have a two-dimensional density along the mesh sheet 50 that ranges between 100 and 400 orifices per square inch. An example of the relationship between the orifices 62, the bridges 66, and the relevant dimensions (e.g., the first dimension 68 and the second dimension 70) are illustrated in Table 1 below. Please note that values may not be limited by table 1.

TABLE 1

| | | Bridge | Orifice | Orifice |
|---|---|---|---|---|
| | | Width/Second | Radius | Diameter/First |
| OPI | Opening Type | dimension (mm) | (mm) | Dimension (mm) |
| 10 | Circle | 0.05 | 1.25 | 2.49 |
| 10 | Hexagon | 0.05 | | 2.88 |
| 10 | Circle | 0.1 | 1.22 | 2.44 |
| 10 | Hexagon | 0.1 | | 2.82 |
| 20 | Circle | 0.05 | 0.61 | 1.22 |
| 20 | Hexagon | 0.05 | | 1.41 |
| 20 | Circle | 0.1 | 0.59 | 1.17 |
| 20 | Hexagon | 0.1 | | 1.35 |

The width of bridges 66 between two openings should be as narrow as possible to ensure high transparency through the mesh sheet 50 (which is desirable for a user who is observing foodstuffs being cooked within the cavity 16) and sufficiently robust to main the overall strength of the mesh sheet 50. Considering the capability of available materials, the width of bridge could be less than 0.1 mm as demonstrated in Table 1, which provides high transparency through the mesh sheet 50 while also providing the mesh sheet 50 with sufficient overall strength so that the mesh sheet is durable.

The mesh sheet 50 may be made from an electrically conductive material, such a metallic material and may have a thickness that is significantly higher than the skin depth of the material. Skin depth is a consideration that illustrates the effectiveness of mesh sheet 50 to operate as a Faraday cage. Skin depth is a measure of the depth at which a current density or an electromagnetic signal attenuates or falls to 1/e (or approximately a third) of its value near the surface. Skin depth is one of several important criteria in determining the type of material and thickness. A material that is too thin will let waves in and possibly resonate or interfere with signal reception or transmission. However a material that is too thick may end up adding unnecessary weight, expense, or both. Skin depth may be illustrated by equation (1):

$$δ s = \sqrt{\frac{2}{ω * μ * σ}} = \sqrt{\frac{1}{π * f * μ * σ}} \qquad ( 1 )$$

Where δs is skin depth (m), μ is permeability (4π*10-7 H/m) [note that H is Henries=Ω*s], ρ is resistivity (Ω*m), ω is radian frequency which is 2π*ƒ (Hz), and σ is conductivity [mho/m) [note that mho=Siemen [S]]. The following table (i.e., Table 2) illustrates the skin depth of materials at different frequencies.

TABLE 2

| | | | | Skin Depth (μm | Skin Depth (μm | Skin Depth (μm |
|---|---|---|---|---|---|---|
| | | | | when subjected | when subjected | when subjected |
| | | | | to a microwave | to a microwave | to a microwave |
| | | Bulk | Relative | energy at a | energy at a | energy at a |
| | Chemical | Resistivity @ | Permeability | frequency of | frequency of | frequency of |
| Material | Formula | 20 C. μΩ × cm | μ/μ0 | 1 GHz) | 2.45 GHz) | 10 GHz) |
| Iron | Fe | 10.1 | 500 | 0.23 | 0.15 | 0.072 |
| Mill Steel/ | Fe alloy | 20 | 800 | 0.25 | 0.16 | 0.08 |
| Stainless | | | | | | |
| Steel | | | | | | |
| Nickel | Ni | 6.9 | 200 | 0.30 | 0.19 | 0.093 |
| Silver | Ag | 1.63 | 1 | 20.03 | 1.30 | 0.643 |
| Copper | Cu | 1.69 | 1 | 2.07 | 1.32 | 0.654 |
| Gold | Au | 2.2 | 1 | 2.36 | 1.51 | 0.747 |
| Aluminum | Al | 2.65 | 1 | 2.59 | 1.65 | 0.819 |
| Beryllium | Be | 3.3 | 1 | 2.89 | 1.85 | 0.914 |
| Brass | Cu70/Zn30 | 7 | 1 | 4.21 | 2.69 | 1.33 |
| Platinum | Pt | 10.58 | 1 | 5.18 | 3.31 | 1.64 |
| Palladium | Pd | 10.8 | 1 | 5.23 | 3.34 | 1.65 |
| Bronze | Cu89/Sn11 | 15 | 1 | 6.16 | 3.94 | 1.95 |
| Nichrome | Ni80/Cr20 | 108 | 1 | 16.5 | 10.57 | 5.23 |
| Carbon | C | 1375 | 1 | 59.0 | 37.7 | 18.7 |
| | (graphite) | | | | | |

The thickness of the mesh sheet 50 (e.g., the dimension of the mesh sheet along direction 64) may be greater than or equal to 0.05 mm (50 μm), which is significantly greater than the skin depth of any metallic material forming the mesh sheet 50. The mesh sheet 50 may be formed from any of the materials described in Table 2, but is preferably made from stainless steel, copper, or any material starting at the top of Table 2 with Iron and down to Bronze (including all materials listed between Iron and Bronze in Table 2). A ratio of a thickness of the mesh sheet 50 to a skin depth of the mesh sheet 50 when subjected to microwave energy at a frequency of 2.45 GHz (which is approximately the microwave energy of standard operating microwave ovens) may range between 10 and 350. However, the ratio of the thickness of the mesh sheet 50 to a skin depth of the mesh sheet 50 when subjected to microwave energy at a frequency of 2.45 GHz may be as low as 1 if Nichrome or Carbon are utilized to from the mesh sheet 50.

The door 18 may be an ultra-thin door when compared to existing microwave oven doors. For example, the whole assembly of the door 18 may have a thickness (e.g., the dimension of the door 18 along direction 64) that is less than 4 millimeters. The door 18 may be electrically coupled to ground through metal components in order to ground the mesh sheet 50. For example, the mesh sheet 50 may have exposed outer edges or an outer region 73 that are or is conductively connected to the hinge 22 to ground the mesh sheet 50. The outer region 73 of the mesh sheet 50 may not include the orifices 62 to ensure that an electrical connection is made to ground. An inner region 75 of the mesh sheet 50 may define the orifices 62. The outer region 73 may extend around an outer periphery of the inner region 75.

The mesh sheet 50 may be blackened by a chemical conversion to reduce reflectivity of the mesh sheet 50, which further increases the transparency of the door assembly through the mesh sheet 50 and glass pane 44. A layer of flexible conductive material, such as a conductive silicone rubber, at the exposed edge of the mesh layer 50 may be utilized to improve the microwave radiation shielding performance. Such a flexible material may also be used to form a seal between the door 18 and housing 12. For example, (i) the frame 34 may define a second recessed region 76 along the interior side of the frame 34 and on an opposing side of the exterior surface 38 and (ii) a seal 78 may be disposed within the second recessed region 76, wherein the seal 78 is configured to engage the microwave housing 12 along or outside of a periphery of the opening 20 defined by the microwave housing 12 to create a ground connection between the mesh sheet 50 and the housing 12. A first region of 80 of the seal 78 may be made from a silicon rubber while a second region 82 of the seal 78 may be made from a conductive rubber.

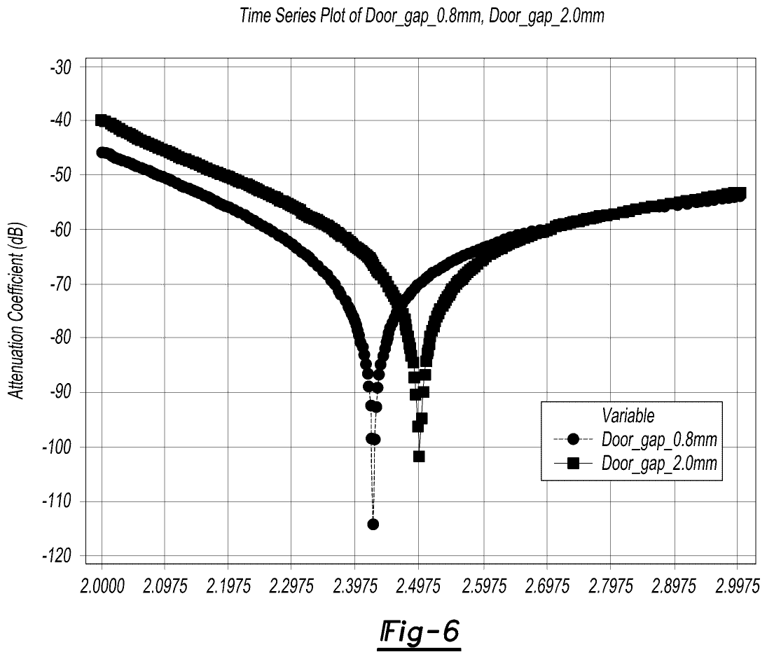

Referring to FIG. 6 and the Table 3 below, a set of graphs and corresponding data comparing the microwave choke of the microwave oven door 18 described herein to the microwave choke of a traditional microwave oven door is illustrated. A larger bandwidth illustrates a better capability of the door choke sealing electromagnetic waves. A smaller dB (attenuation coefficient) also illustrates a better capability of the door choke sealing electromagnetic waves. The microwave oven door 18 described herein (also referred to as the ultra-thin door) has a smaller minimum attenuation coefficient relative to the traditional microwave oven door illustrating a greater capability of the door choke of the microwave oven door 18 to seal electromagnetic waves when compared to a traditional door.

TABLE 3
Ultra-thin door VS Traditional door - door choke simulation result

| | | | Cut off | |
|---|---|---|---|---|
| | Door | | frequency/ | Bandwidth/MHZ |
| Concept | Gap/mm | Min/dB | GHz | (under −60 dB) |
| Traditional Door | 0.8 | −101 | 2.387 | 50 |
| Traditional Door | 2 | −76 | 2.365 | 10 |
| Ultra Thin Door | 0.8 | −114 | 2.425 | 426 |
| Ultra Thin Door | 2 | −101 | 2.497 | 343 |

It should be understood that the designations of first, second, third, fourth, etc. for any component, state, or condition described herein may be rearranged in the claims so that they are in chronological order with respect to the claims. Furthermore, it should be understood that any component, state, or condition described herein that does not have a numerical designation may be given a designation of first, second, third, fourth, etc. in the claims if one or more of the specific component, state, or condition are claimed.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A microwave oven comprising:
a housing defining an internal cavity configured to receive foodstuffs therein; and
a door rotatably secured to the housing, the door having,
a glass pane, and
a mesh sheet secured to an internal surface of the glass pane and exposed along an interior side of the door, wherein (i) the housing and mesh sheet collectively form a faraday cage when the door is in a closed position, (ii) the mesh sheet defines orifices, (iii) the mesh sheet includes bridges of solid material separating the orifices, and (iv) the orifices each have a first dimension spanning opposing ends of the orifices, (v) the bridges each have a second dimension spanning the bridges and extending between adjacent orifices, and (vi) a ratio of the first dimension to the second dimension ranges between 10 and 60.

2. The microwave oven of claim 1, wherein a one-dimensional density of the orifices defined along the mesh sheet ranges between 10 and 20 orifices per inch.

3. The microwave oven of claim 1, wherein a two-dimensional density of the orifices defined along the mesh sheet ranges between 100 and 400 per square inch.

4. The microwave oven of claim 1, wherein a ratio of a thickness of the mesh sheet to a skin depth of the mesh sheet when subjected to microwave energy at a frequency of 2.45 GHz ranges between 10 and 350.

5. The microwave oven of claim 1, wherein the second dimension of each bridge corresponds a shortest distance between corresponding adjacent orifices along each bridge.

6. The microwave oven of claim 1, wherein the orifices are hexagonal in shape and the first dimension of each orifice corresponds to a long diagonal dimension of the corresponding orifice.

7. The microwave oven of claim 1, wherein the orifices are circular in shape and the first dimension of each orifice corresponds to a diameter of the corresponding orifice.

8. A microwave oven door comprising:
a frame defining a central opening, having an exterior surface extending around an outer periphery of the central opening, and having a recessed region extending inward from the exterior surface, wherein the recessed region extends around the outer periphery of the central opening and is disposed between the exterior surface and the central opening;
a transparent pane having an outer surface and an inner surface, and secured to the frame within the recessed region such that the outer surface is planar with the exterior surface of the frame; and
a mesh sheet defining an array of orifices and secured to the inner surface of the transparent pane such that the mesh sheet is planar with an interior surface of the frame and is exposed along an interior side of the frame via the central opening, wherein the mesh sheet is collectively configured to form a faraday cage with a microwave housing.

9. The microwave oven door of claim 8, wherein the frame defines a second recessed region along the interior side of the frame and on an opposing side of the exterior surface.

10. The microwave oven door of claim 9 further comprising a seal disposed within the second recessed region, wherein the seal is configured to engage the microwave housing along a periphery of an opening defined by the microwave housing.

11. The microwave oven door of claim 8, wherein the interior surface of the frame is defined along the recessed region.

12. The microwave oven door of claim 8, wherein the mesh sheet includes bridges of solid material separating the orifices within the array of orifices, the orifices each have a first dimension spanning opposing ends of the orifices, the bridges each have a second dimension spanning the bridges and extending between adjacent orifices, and a ratio of the first dimension to the second dimension ranges between 10 and 60.

13. The microwave oven door of claim 8, wherein a density of the array of orifices defined along the mesh sheet ranges between 10 and 20 orifices per inch.

14. A microwave oven comprising:
a housing defining an internal cavity; and
a door movably secured to the housing, the door having,
a glass pane, and
a mesh sheet secured to an internal surface of the glass pane and exposed along an interior side of the door, wherein the housing and mesh sheet collectively form a faraday cage when the door is in a closed position.

15. The microwave oven of claim 14, wherein mesh sheet defines orifices, and a density of the orifices defined along the mesh sheet ranges between 10 and 20 orifices per inch.

16. The microwave oven of claim 15, wherein a two-dimensional density of the orifices defined along the mesh sheet ranges between 100 and 400 per square inch.

17. The microwave oven of claim 15, wherein the mesh sheet includes bridges of solid material separating the orifices, and the orifices each have a first dimension spanning opposing ends of the orifices, the bridges each have a second dimension spanning the bridges and extending between adjacent orifices, and a ratio of the first dimension to the second dimension ranges between 10 and 60.

18. The microwave oven of claim 17, wherein the orifices are circular in shape and the first dimension of each orifice corresponds to a diameter of the corresponding orifice.

19. The microwave oven of claim 17, wherein the orifices are hexagonal in shape and the first dimension of each orifice corresponds to a long diagonal dimension of the corresponding orifice.

20. The microwave oven of claim 17, wherein the second dimension of each bridge corresponds a shortest distance between corresponding adjacent orifices along each bridge.
